(19) United States
(12) Patent Application Publication
(10) Pub. No.: US 2022/0004050 A1
(43) Pub. Date: Jan. 6, 2022

(54) DISPLAY MODULE AND ASSEMBLING METHOD THEREOF

(71) Applicant: WUHAN CHINA STAR OPTOELECTRONICS TECHNOLOGY CO., LTD., Wuhan (CN)

(72) Inventor: Pengfei YU, Wuhan (CN)

(73) Assignee: WUHAN CHINA STAR OPTOELECTRONICS TECHNOLOGY CO., LTD., Wuhan (CN)

(21) Appl. No.: 16/632,353

(22) PCT Filed: Nov. 8, 2019
(86) PCT No.: PCT/CN2019/116722

§ 371 Date: Jan. 19, 2020

(30) Foreign Application Priority Data
Aug. 13, 2019 (CN) 201910742591.2

(51) Int. Cl. G02F 1/1335

(52) U.S. Cl. CPC G02F 1/133512; G02F 2202/28; G02F 1/133528

(57) ABSTRACT

The disclosure provides a display module and an assembling method thereof. A blind hole protective film is attached to a blind hole area of an LCD panel before light-shading adhesives are coated on the blind hole area. Therefore, the light-shading adhesives may be predeterminedly coated on a notch, thereby improving coating accuracy and coating appearance of the light-shading adhesives. By cooperation of the first light-shading layer and the second light-shading layer, a problem that display effect and camera function of products are affected because light in backlight module leaks to the blind hole area is prevented, and the blind hole area is effectively prevented from being interfered by foreign matters.

### FIELD

The present disclosure relates to the field of display, and more particularly, relates to a display module and an assembling method thereof.

### BACKGROUND

With continuous development of display industry and display technology, full-screen display technology having high screen-to-body ratio, larger effective display area, and better display effect gradually becomes a mainstream. In conventional full-screen display panels, an earphone and a rear camera are disposed at a bottom side of display panels to realize full-screen display function, which involves an internal opening technology of panels.

In current industry, when a backlight module and a display panel are assembled, a light-shading adhesive is coated on a blind hole area, thereby preventing light emitted from the backlight module from leaking to the blind hole area and affecting display effect and camera function of products. However, some adhesives are not well coated on the blind hole area so that light emitted from the backlight module leaks to the blind hole area through non-well-coated adhesives, thereby affecting a camera in a blind hole of a liquid crystal display (LCD) device.

Consequently, in conventional LCD devices, some adhesives are not well coated on a blind hole area, which needs to be solved.

Regarding the technical problem: the present disclosure provides a display module and an assembling method thereof to alleviate a problem that some adhesives are not well coated on a periphery of a blind hole in conventional LCD devices.

### SUMMARY

To solve the above problem, technical solutions provided by the present disclosure are described as follows:

The present disclosure provides a display module, including: a liquid crystal display (LCD) panel, wherein a blind hole is defined in a position of the LCD panel corresponding to a camera lens; a bottom polarizer attached to a light entrance side of the LCD panel, wherein a first through hole is defined in a position of the bottom polarizer corresponding to the blind hole; a first light-shading layer disposed in the first through hole and in contact with a periphery of the first through hole of the bottom polarizer; a backlight module attached to the first light-shading layer by an adhesive layer, wherein a second through hole is defined in a position of the backlight module corresponding to the blind hole; and a second light-shading layer disposed in the second through hole and in contact with the first light-shading layer, the adhesive layer, and a periphery of the second through hole of the backlight module, wherein an area surrounded by the second light-shading layer at least overlaps with a portion of a blind hole area.

In the display module provided by the present disclosure, a size of the first through hole is greater than a size of the blind hole, and the blind hole area is located in a first through hole area.

In the display module provided by the present disclosure, a thickness of the first light-shading layer and a thickness of the bottom polarizer are the same.

In the display module provided by the present disclosure, a thickness of the first light-shading layer is greater than a thickness of the bottom polarizer.

In the display module provided by the present disclosure, a thickness of the first light-shading layer is less than a thickness of the bottom polarizer, and the sum of thicknesses of the first light-shading layer and the adhesive layer is greater than the thickness of the bottom polarizer.

In the display module provided by the present disclosure, an area surrounded by the first light-shading layer is greater than the blind hole area, and the blind hole area is located in the area surrounded by the first light-shading layer.

In the display module provided by the present disclosure, an area surrounded by the first light-shading layer overlaps with the blind hole area.

In the display module provided by the present disclosure, an area surrounded by the first light-shading layer is less than the blind hole area, and the area surrounded by the first light-shading layer is in the blind hole area.

In the display module provided by the present disclosure, the second light-shading layer is formed on the LCD panel.

In the display module provided by the present disclosure, an area surrounded by the first light-shading layer overlaps with the blind hole area.

In the display module provided by the present disclosure, an area surrounded by the first light-shading layer is less than the blind hole area, and the area surrounded by the first light-shading layer is in the blind hole area.

In the display module provided by the present disclosure, the area surrounded by the second light-shading layer is greater than the blind hole area, and the area surrounded by the second light-shading layer is in the blind hole area.

In the display module provided by the present disclosure, the second light-shading layer is formed on the first light-shading layer.

In the display module provided by the present disclosure, the area surrounded by the second light-shading layer overlaps with the area surrounded by the first light-shading layer.

The present disclosure further provides an assembling method of a display module, including the following steps: providing a liquid crystal display (LCD) panel, wherein a blind hole is defined in a position of the LCD panel corresponding to a camera lens; attaching a polarizer and a blind hole protective film to the LCD panel, wherein a bottom polarizer and the blind hole protective film are attached to a light entrance side of the LCD panel, a first through hole is defined in a position of the bottom polarizer corresponding to the blind hole, a size of the first through hole is greater a size of a blind hole area, and the blind hole protective film is attached to the blind hole area; forming a first light-shading layer by a first adhesive coating process, wherein the first light-shading layer is formed in the first through hole and is in contact with a periphery of the first through hole of the bottom polarizer; attaching the LCD panel to a backlight module by an adhesive layer, wherein a second through hole is defined in a position of the backlight module corresponding to the blind hole; forming a second light-shading layer by a second adhesive coating process, wherein the second light-shading layer is formed in the second through hole and is in contact with the adhesive layer and a periphery of the second through hole of the backlight module; and peeling off the blind hole protective film.

In the assembling method provided by the present disclosure, the step of attaching the LCD panel to the polarizer includes: attaching a top polarizer to a light exit side of the LCD panel, and attaching the bottom polarizer to the light entrance side of the LCD panel.

In the assembling method provided by the present disclosure, the polarizer is attached to the LCD panel before the blind hole protective film is attached to the LCD panel.

In the assembling method provided by the present disclosure, the polarizer is attached to the LCD panel after the blind hole protective film is attached to the LCD panel.

In the assembling method provided by the present disclosure, the assembling method includes: encapsulating the LCD panel after the polarizer is attached to the LCD panel.

In the assembling method provided by the present disclosure, the first adhesive coating process includes: coating a light-shading adhesive on a recess surrounded by the bottom polarizer and the blind hole protective film by an inject printing process to form the first light-shading layer.

Regarding the beneficial effect: the present disclosure provides a display module and an assembling method thereof. A blind hole protective film is attached to a blind hole area of an LCD panel before light-shading adhesives are coated on the blind hole area. A first light-shading layer is confined in a notch surrounded by the blind hole protective film and a bottom polarizer when the first light-shading layer is manufactured. A second light-shading layer is confined in a notch surrounded by the blind hole protective film and a backlight module when the second light-shading layer is manufactured. Therefore, the light-shading adhesives may be predeterminedly coated on the notch, thereby improving coating accuracy and coating appearance. By cooperation of the first light-shading layer and the second light-shading layer, a problem that display effect and camera function of products are affected because light in the backlight module leaks to the blind hole area is prevented. The blind hole protective film is attached to the blind hole before two light-shading layers are formed and is peeled off after the second light-shading layer is formed, thereby effectively preventing the blind hole area from being interfered by foreign matters.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic top view showing a display module provided by an embodiment of the present disclosure.

FIG. 2 is a first cross-sectional view taken along line A-A′ showing a partial area of a display module provided by an embodiment of the present disclosure.

FIG. 3 is a second cross-sectional view taken along line A-A′ showing a partial area of a display module provided by an embodiment of the present disclosure.

FIG. 4 is a flowchart showing an assembling method of a display panel provided by an embodiment of the present disclosure.

FIG. 5(a) to FIG. 5(h) are schematic views showing assembling processes of a display panel provided by an embodiment of the present disclosure.

### DETAILED DESCRIPTION

The following description of the various embodiments is provided with reference to the accompanying drawings. It should be understood that terms such as “upper”, “lower”, “front”, “rear”, “left”, “right”, “inside”, “outside”, “lateral”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In the drawings, the identical or similar reference numerals constantly denote the identical or similar elements or elements having the identical or similar functions.

The present disclosure provides a display module to solve a problem that some adhesives are not well coated on a periphery of a blind hole in conventional LCD devices.

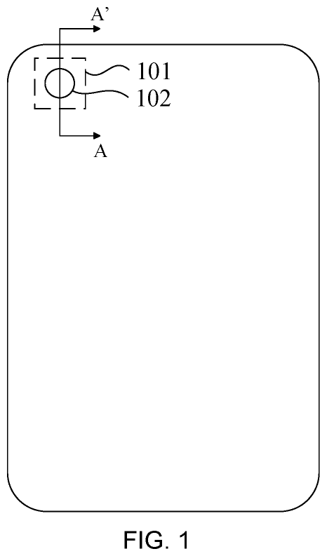

In one embodiment, as shown in FIG. 1 to FIG. 3, a display module provided by the present disclosure includes an LCD panel 10, a polarizer 20, an encapsulation layer 40, a first light-shading layer 51, a backlight module 70, and a second light-shading layer 52.

The LCD panel 10 includes an array substrate 11, a color filter 12, and liquid crystals 13 filled between the array substrate 11 and the color filter 12. A blind hole is defined in a position of the LCD panel 10 corresponding to a camera, and the position is a blind hole area 102.

The polarizer 20 includes a top polarizer 21 and a bottom polarizer 22, the top polarizer 21 is attached to the color filter 12, the bottom polarizer 22 is attached to the array substrate 11, and a through hole is defined in positions of the top polarizer 21 and the bottom polarizer 22 which correspond to the blind hole. A through hole area 103 is the position of the top polarizer 21 where the through hole is defined in, a first through hole area 104 is the position where the through hole of the bottom polarizer 22 is defined in, and the through hole of the bottom polarizer 22 is a first through hole.

The encapsulation layer 40 is configured to encapsulate the LCD panel 10 by an optically clear adhesive (OCA) 30.

The first light-shading layer 51 is disposed in the first through hole area 104 and is in contact with the bottom polarizer 22 at a periphery of the first through hole.

The backlight module 70 is attached to the first light-shading layer 51 by an adhesive layer 60, a second through hole is defined in a position of the backlight module 70 corresponding to the blind hole, and the position is a second through hole area 105.

The second light-shading layer 52 is disposed in the second through hole area 105 and is in contact with the first light-shading layer 51, the adhesive layer 60, and the backlight module 70 which are at a periphery of the second through hole, and an area surrounded by the second light-shading layer 52 overlaps with at least a portion of the blind hole area 102.

The present embodiment provides a display module. In the display module, a first light-shading layer is disposed in a through hole area of a bottom polarizer, which effectively blocks light that may pass through a lateral side of the bottom polarizer in a backlight module, thereby preventing light from leaking from the lateral side of the bottom polarizer. Furthermore, a second light-shading layer is disposed in a through hole area of the backlight module, which further blocks light which may leak from an adhesive layer. By cooperation of the first-shading layer and the second light-shading layer, a risk of light leakage because of non-well-coated adhesives and interference of adhesives can be prevented, and a problem that display effect and camera function of products are affected because light in the backlight module leaks to the blind hole area is effectively solved.

In one embodiment, a shape of the blind hole area 102 is typically a circle, while in other embodiments, the shape of the blind hole area 102 may be other shapes. The shape of the blind hole area 102 may be designed according to practical requirements and is not limited here.

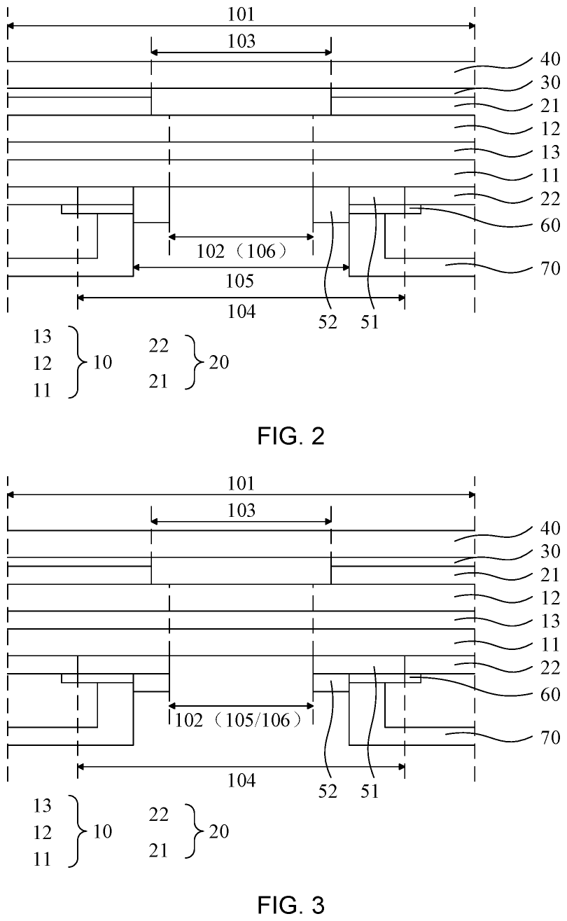

In one embodiment, a shape of the through hole area 103 of the top polarizer 21 and a shape of the first through hole area 104 of the bottom polarizer 22 are same as the shape of the blind hole area 102. A size of the through hole area 103 and a size of the first through hole area 104 are greater than a size of the blind hole area 102 to prevent incident light path or incident light area of a camera from being blocked by the polarizer 20 and prevent light in the backlight module 70 from directly leaking from the lateral side of the bottom polarizer 22. The size of the through hole area 103 may be same as, less than, or greater than the size of the first through hole area 104. In FIG. 2 and FIG. 3, the size of the through hole area 103 of the top polarizer 21 is less than the size of the first through hole area 104 of the bottom polarizer 22.

In one embodiment, as shown in FIG. 2 and FIG. 3, a thickness of the first light-blocking layer 51 is same as a thickness of the bottom polarizer 22. In another embodiment, the thickness of the first light-blocking layer 51 is greater than the thickness of the bottom polarizer 22, which can effectively prevent light from leaking from the lateral side of the polarizer 22. The first light-shading layer 51 extends to a position where the LCD panel 10 and the backlight module 70 are assembled, whereby better contact is achieved between the LCD panel 10 and the backlight module 70 when they are assembled.

In one embodiment, as shown in FIG. 2, the second through hole area 105 surrounded by the first light-shading layer 51 is greater than the blind hole area 102, the blind hole area 102 is located in the second through hole area 105 surrounded by the first light-shading layer 51, the second light-shading layer 52 is formed on the LCD panel 10 and is in contact with the first light-shading layer 51, the adhesive layer 60, and the backlight module 70, thereby ensuring that light emitted from the backlight module 70 will not leak from the adhesive layer 60. By cooperation of the second light-shading layer 52 and the first light-shading layer 51, light emitted from the backlight module 70 is prevented from leaking, and a light leakage problem because of non-well-coated adhesives or interference of adhesive layer is prevented.

In one embodiment, as shown in FIG. 2, an area 106 surrounded by the second light-shading layer 52 overlaps with the blind hole area 105. In another embodiment, the area 106 surrounded by the second light-shading layer 52 is greater than the blind hole area 102, and the blind hole area 102 is located in the area 106 surrounded by the second light-blocking layer 52. In yet another embodiment, the area 106 surrounded by the second light-blocking layer 52 is less than the blind hole area 102, and the area 106 surrounded by the second light-blocking layer 52 is located in the blind hole area 102.

In another embodiment, as shown in FIG. 3, the second through hole area 105 surrounded by the first light-shading layer 51 overlaps with the blind hole area 102, and the second light-shading layer 52 is formed on the second light-shading layer 52 and is in contact with the adhesive layer 60 and the backlight module 70, thereby ensuring that light emitted from the backlight module 70 will not leak from the adhesive layer 60. By cooperation of the second light-shading layer 52 and the first light-shading layer 51, light emitted from the backlight module 70 is prevented from leaking, and a light leakage problem because of non-well-coated adhesives or interference of adhesive layer is prevented. In the present embodiment, the area 106 surrounded by the second light-shading layer 52 overlaps with the blind hole area 102.

In another embodiment, the second through hole area 105 surrounded by the first light-shading layer 51 is less than the blind hole area 102, the second light-shading layer 52 is formed on the second light-shading layer 52 and is in contact with the adhesive layer 60 and the backlight module 70, thereby ensuring that light emitted from the backlight module 70 will not leak from the adhesive layer 60. By cooperation of the second light-shading layer 52 and the first light-shading layer 51, light emitted from the backlight module 70 is prevented from leaking, and a light leakage problem because non-well-coated adhesives or interference of adhesive layer is prevented. In the present embodiment, the area 106 surrounded by the second light-shading layer 52 overlaps with the blind hole area 102.

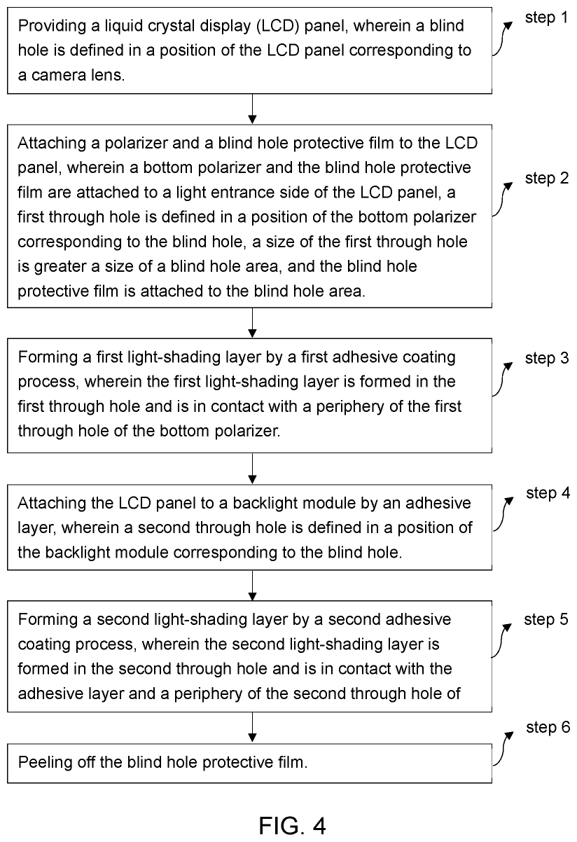

As shown in FIG. 4, the present disclosure further provides an assembling method of a display module, including the following steps:

step 1: providing a liquid crystal display (LCD) panel, wherein a blind hole is defined in a position of the LCD panel corresponding to a camera;

step 2: attaching a polarizer and a blind hole protective film to the LCD panel, wherein a bottom polarizer and the blind hole protective film are attached to a light entrance side of the LCD panel, a first through hole is defined in a position of the bottom polarizer corresponding to the blind hole, a size of the first through hole is greater a size of a blind hole area, and the blind hole protective film is attached to the blind hole area;

step 3: forming a first light-shading layer by a first adhesive coating process, wherein the first light-shading layer is formed in the first through hole and is in contact with a periphery of the first through hole of the bottom polarizer;

step 4: attaching the LCD panel to a backlight module by an adhesive layer, wherein a second through hole is defined in a position of the backlight module corresponding to the blind hole;

step 5: forming a second light-shading layer by a second adhesive coating process, wherein the second light-shading layer is formed in the second through hole and is in contact with the adhesive layer and a periphery of the second through hole of the backlight module; and

step 6: peeling off the blind hole protective film.

The present embodiment provides an assembling method of a display module. A blind hole protective film is attached to a blind hole of an LCD panel before light-shading adhesives are coated on the blind hole. A first light-shading layer is confined in a notch surrounded by the blind hole protective film and a bottom polarizer when the first light-shading layer is manufactured. A second light-shading layer is confined in a notch surrounded by the blind hole protective film and a backlight module when the second light-shading layer is manufactured. The above two notches are respectively provided for two coating processes so that the light-shading adhesives may be predeterminedly coated on the notch, thereby improving coating accuracy and coating appearance and preventing a problem that display effect and camera function of products are affected because light in the backlight module leaks to the blind hole area. The blind hole protective film is attached to the blind hole area before two light-shading layers are formed and is peeled off after the second light-shading layer is formed, thereby effectively preventing the blind hole area from being interfered by foreign matters.

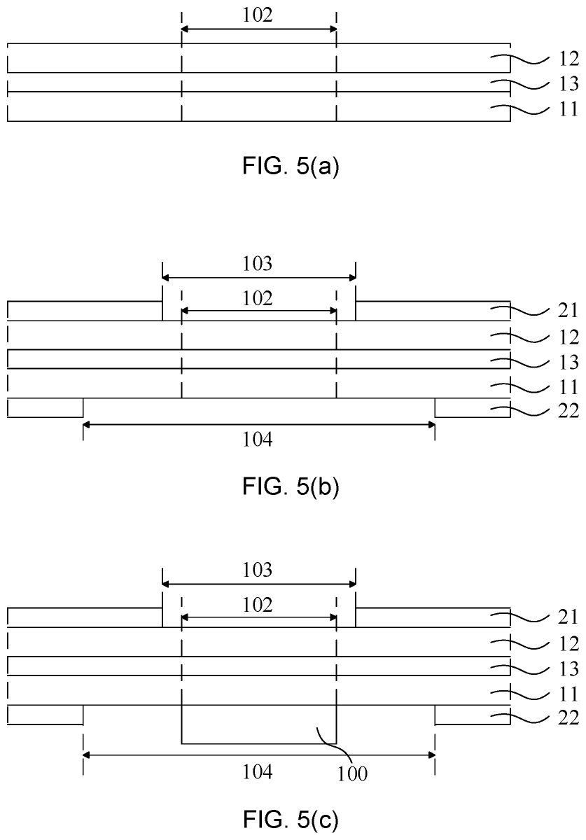

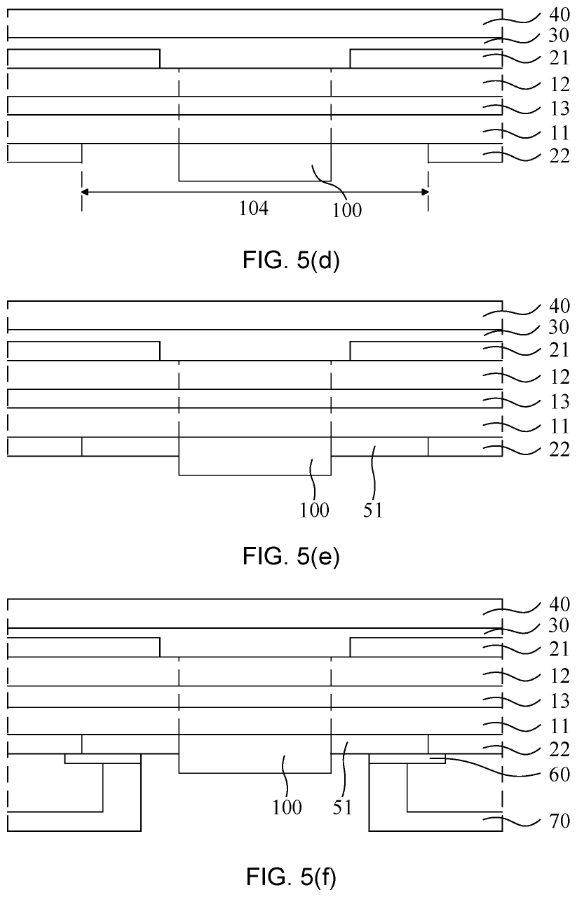

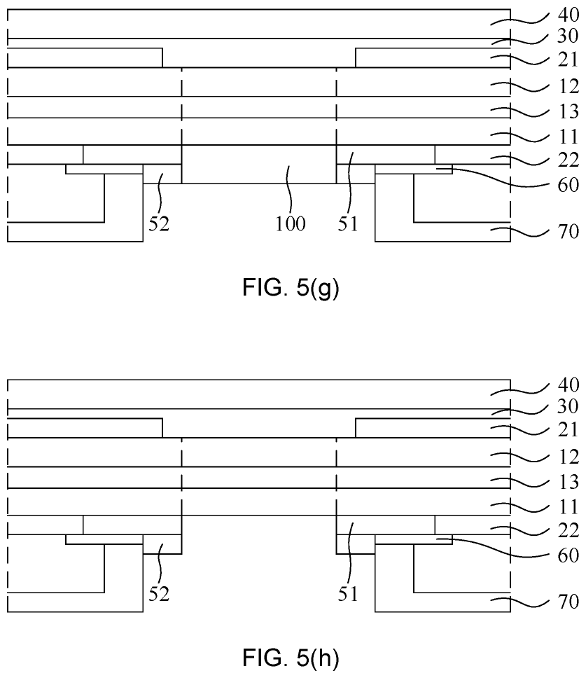

In one embodiment, as shown in FIG. 5(a), an LCD panel provided by the step 1 includes:

step 11: respectively manufacturing an array substrate 11 and a color filter 12, and defining a hole on positions of the array substrate 11 and the color filter 12 which have a relatively strong light-blocking ability and correspond to a position of a camera.

Specifically, a step of manufacturing the array substrate includes the following steps: providing a glass substrate, and sequentially forming a buffer layer, an active layer, a gate insulating layer, a gate layer, an interlayer insulating layer, a source/drain layer, a passivation layer, a pixel electrode layer, a planarization layer, and a first alignment film on the glass substrate. In processes of manufacturing the above layers, an opening is defined in films, which have relatively a strong light-blocking ability, such as the gate layer, the source/drain layer, and the pixel electrode layer, and the opening is filled with materials having relatively weak light-blocking ability in a next process. The above films may be manufactured by conventional technologies, and manufacturing methods of the above films are not limited here.

Specifically, a step of manufacturing the color filter includes the following steps: providing a glass substrate, forming a black matrix layer on the glass substrate, patterning the black matrix layer to confine a photoresist area, sequentially and repeatedly filling a red photoresist, a green photoresist, and a blue photoresist into the photoresist area formed from a photoresist layer, defining an opening in positions of the photoresist layer and the black matrix layer which correspond to the blind hole area, evaporating a common electrode layer onto the entire surfaces of photoresist layer and the black matrix layer, defining an opening in a position of the common electrode layer corresponding to the blind hole area, and forming a planarization layer, a second alignment layer, and a spacer on the common electrode layer.

In the present embodiment, a size of a blind hole area on the array substrate and a size of a blind hole area on the color filter are the same and correspond to each other. In one embodiment, a shape of the blind hole area is a circle, while in other embodiments, the blind hole area may be other shapes.

The LCD panel provided by the step 1 further includes: step 12: aligning the array substrate 11 with the color filter 12, and filling liquid crystals 13 therebetween.

Specifically, the step 12 may be: first injecting the liquid crystals 13 from the array substrate 11 or from the color filter 12, then aligning the array substrate 11 with the color filter 12; alternatively, first aligning the array substrate 11 with the color filter 12, then injecting the liquid crystals 13 therebetween. Specific injecting method of liquid crystals 13 is not limited here.

In one embodiment, as shown in FIG. 5(b), the step of attaching the polarizer to the LCD panel includes:

attaching a top polarizer 21 to the color filter 12 and attaching a bottom polarizer 22 to the array substrate 11. As shown in FIG. 5(b), a through hole is defined in both positions of the top polarizer 21 and the bottom polarizer 22 which correspond to the blind hole, the through hole of the top polarizer 21 is a top through hole, and the through hole of the bottom polarizer 22 is a first through hole. Attaching processes of the top polarizer 21 and the bottom polarizer 22 may be performed before or after an attaching process of the blind hole protective film.

In the present embodiment, a shape of the through hole of the top polarizer 21, a shape of the through hole of the bottom polarizer 22, and a shape of the blind hole area are a circle. To prevent incident light path or incident light area of an optical device from being blocked by the polarizer and prevent light in the backlight module from directly leaking from the lateral side of the bottom polarizer 22, a size of the top through hole area 103 is greater than or same as a size of the blind hole area 102, and a size of the first through hole area 104 is greater than the size of the blind hole area 102. The size of the top through hole area 103 may be same as, less than, or greater than the size of the first through hole area 104

In one embodiment, as shown in FIG. 5(c), the step of attaching the blind hole protective film the blind hole area of the display panel specifically includes:

coating an adhesive substance on the blind hole area 102 of the display panel, and then attaching a blind hole protective film 100 to the blind hole area 102. In one embodiment, a size of the blind hole protective film 100 is same as the size of the blind hole area 102. In other embodiments, the size of the blind hole protective film 100 is less than the size of the blind hole area 102. A thickness of the blind hole protective film 100 is greater than a thickness of the bottom polarizer 22, and a bottom surface, which is away from the array substrate 11, of the blind hole protective film 100 is below a top surface of an assembly of the backlight module and the display panel. The adhesive substance between the display panel and the blind hole protective film 100 is a photosensitive adhesive, a temperature sensitive adhesive, or a double-sided tape.

In one embodiment, as shown in FIG. 5(d), the assembling method of the display module further includes: performing a chip bonding process and an encapsulation process on the LCD panel which is attached to the top polarizer and the bottom polarizer.

Specifically, a driver chip and a printed circuit board are crimped on a binding region of the display panel by an anisotropic conductive film (ACF), and then the display panel is glass-encapsulated or thin-film-encapsulated. An encapsulation layer is a transparent cover plate which is a hard plate with a certain mechanical strength and high transmittance. In one embodiment, the transparent plate is a glass plate which has high transmittance and low cost. In other embodiments, the transparent plate may also be a plastic plate. The display panel is attached to the transparent plate by an optically clear adhesive (OCA). The OCA has good bonding ability and high transparency, which only slightly affects display effect of the display panel.

In one embodiment, as shown in FIG. 5(e), a first coating process in the step 3 specifically includes: coating a light-shading adhesive on a notch surrounded by the bottom polarizer 22 and the blind hole protective film 100 by inkjet printing to form a first light-shading layer 51. In the first coating process, the inkjet printing may be performed in a way that coating the light-shading adhesive on a spinning LCD panel by a stationary spray; alternatively, the inkjet printing may be performed in a way that coating the light-shading adhesive on a stationary LCD panel by a spinning spray.

In the present embodiment, the notch surrounded by the bottom polarizer 22 and the blind hole protective film 100 is a tunnel area confined by the bottom polarizer 22 and the blind hole protective film 100, and the bottom of the tunnel area is the display panel. Therefore, an area for the first coating process is precisely confined so that the light-shading adhesive may be coated along peripheries of the polarizer and the blind hole protective film 100, and the first light-shading layer 51 having high coating accuracy and good coating appearance may be formed. A thickness of the first light-shading layer 51 is greater than or same as a thickness of the bottom polarizer 22, which can effectively prevent light from leaking from the lateral side of the bottom polarizer 22. The first light-shading layer 51 extends to a position where the LCD panel and the backlight module are assembled, whereby better contact is achieved between the LCD panel and the backlight module when they are assembled.

In one embodiment, as shown in FIG. 5(f), the step of attaching the backlight module to the LCD panel in the step 4 specifically includes: forming an adhesive layer on a position of the display panel to which the backlight module is attached, and then crimping the adhesive layer on the adhesive layer, wherein the adhesive layer is a double-sided tape which is configured to attach the LCD panel to the backlight module. In the present embodiment, a through hole is defined in a position of the backlight module corresponding to the blind hole.

In one embodiment, as shown in FIG. 5(g), a second coating process in the step 5 is similar to the first coating process in the step 3. Specifically, a light-shading adhesive is coated on a notch surrounded by the blind hole protective film and the backlight module by inkjet printing to form a second light-shading layer. In the second coating process, the inkjet printing may be performed in a way that coating the light-shading adhesive on a spinning LCD panel by a stationary spray; alternatively, the inkjet printing may be performed in a way that coating the light-shading adhesive on a stationary LCD panel by a spinning spray.

In the present embodiment, the notch surrounded by the blind hole protective film 100 and the backlight module is a tunnel area confined by the blind hole protective film 100 and the backlight module, and the bottom of the tunnel area is the display panel or the first light-shading layer. Therefore, an area for the second coating process is precisely confined so that the light-shading adhesive may be coated along peripheries of the backlight module and the blind hole protective film 100, and the second light-shading layer having high coating accuracy and good coating appearance may be formed. A top of the second light-shading layer, which is near the display panel, is connected to the first light-shading layer, and a bottom surface, which is away from the display panel, is below a top surface of the backlight module, thereby improving light-shading effect and preventing light-leakage problem because of non-well-coated adhesives or interference of adhesive layer.

By attaching the blind hole protective film to the blind hole area, the blind hole area may be protected, and areas for coating the first light-shading layer and the second light-shading layer may be precisely confined simultaneously. Therefore, coating effects and coating appearances of the first light-shading layer and the second light-shading layer may be improved. By cooperation of the first light-shading layer and the second light-shading layer, light-leakage because of non-well-coated adhesives or interference of adhesive is prevented, and transmittance of an optical device is improved.

In one embodiment, as shown in FIG. 5(h), the blind hole protective film is peeled off after the second coating process is finished.

The present disclosure further provides a display device, including a display module. The display module includes:

an LCD panel, wherein a blind hole is defined in a position of the LCD panel corresponding to a camera;

a bottom polarizer attached to a light entrance side of the LCD panel, wherein a first through hole is defined in a position of the bottom polarizer corresponding to the blind hole;

a first light-shading layer disposed in the first through hole and in contact with a periphery of the first through hole of the bottom polarizer;

a backlight module attached to the first light-shading layer by an adhesive layer, wherein a second through hole is defined in a position of the backlight module corresponding to the blind hole; and

a second light-shading layer disposed in the second through hole area and is in contact with the first light-shading layer, the adhesive layer, and the backlight module which are at a periphery of the second through hole, wherein an area surrounded by the second light-shading layer at least overlaps with a portion of the blind hole area.

The present embodiment provides a display device including a display module. In the display module, a first light-shading layer is disposed in a through hole area of a bottom polarizer, which effectively blocks light which may pass through a lateral side of the bottom polarizer in a backlight module, thereby preventing light from leaking from the lateral side of the bottom polarizer. Furthermore, a second light-shading layer is disposed in a through hole area of the backlight module, which further blocks light that may leak from an adhesive layer. By cooperation of the first-shading layer and the second light-shading layer, a risk of light leakage because of non-well-coated adhesives and interference of adhesives can be prevented, and a problem that display effect and camera function of products are affected because light in the backlight module leaks to the blind hole area is effectively solved.

In one embodiment, a size of the first through hole is greater than a size of the blind hole, and the blind hole area is located in a first through hole area.

In one embodiment, a thickness of the first light-shading layer and a thickness of the bottom polarizer are the same.

In one embodiment, a thickness of the first light-shading layer is greater than a thickness of the bottom polarizer.

In one embodiment, an area surrounded by the first light-shading layer is greater than the blind hole area, and the blind hole area is located in the area surrounded by the first light-shading layer.

In one embodiment, the area surrounded by the first light-shading layer overlaps with the blind hole area.

In one embodiment, an area surrounded by the first light-shading layer is greater than the blind hole area, and the blind hole area is located in the area surrounded by the first light-shading layer.

In one embodiment, the second light-shading layer is formed on the LCD panel.

In one embodiment, an area surrounded by the second light-shading layer is greater than the blind hole area, and the blind hole area is located in the area surrounded by the second light-shading layer.

In one embodiment, the area surrounded by the second light-shading layer overlaps with the blind hole area.

In one embodiment, an area surrounded by the second light-shading layer is less than the blind hole area, and the blind hole area is located in the area surrounded by the second light-shading layer.

In one embodiment, the second light-shading layer is formed on the first light-shading layer.

In one embodiment, the area surrounded by the second light-shading layer overlaps with the area surrounded by the first light-shading layer.

According to the above embodiments, the present disclosure provides a display module and an assembling method thereof. A blind hole protective film is attached to a blind hole of an LCD panel before light-shading adhesives are coated on the blind hole. A first light-shading layer is confined in a notch surrounded by the blind hole protective film and a bottom polarizer when the first light-shading layer is manufactured. A second light-shading layer is confined in a notch surrounded by the blind hole protective film and a backlight module when the second light-shading layer is manufactured. Therefore, the light-shading adhesives may be predeterminedly coated on the notch, thereby improving coating accuracy and coating appearance. By cooperation of the first light-shading layer and the second light-shading layer, a problem that display effect and camera function of products are affected because light in the backlight module leaks to the blind hole area is prevented. The blind hole protective film is attached to the blind hole before two light-shading layers are formed and is peeled off after the second light-shading layer is formed, thereby effectively preventing the blind hole from being interfered by foreign matters.

To sum up, the present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

1. A display module, comprising:
a liquid crystal display (LCD) panel, wherein a blind hole is defined in a position of the LCD panel corresponding to a camera lens;
a bottom polarizer attached to a light entrance side of the LCD panel, wherein a first through hole is defined in a position of the bottom polarizer corresponding to the blind hole;
a first light-shading layer disposed in the first through hole and in contact with a periphery of the first through hole of the bottom polarizer;
a backlight module attached to the first light-shading layer by an adhesive layer, wherein a second through hole is defined in a position of the backlight module corresponding to the blind hole; and
a second light-shading layer disposed in the second through hole and in contact with the first light-shading layer, the adhesive layer, and a periphery of the second through hole of the backlight module, wherein an area surrounded by the second light-shading layer at least overlaps with a portion of a blind hole area.

2. The display module of claim 1, wherein a size of the first through hole is greater than a size of the blind hole, and the blind hole area is located in a first through hole area.

3. The display module of claim 2, wherein a thickness of the first light-shading layer and a thickness of the bottom polarizer are the same.

4. The display module of claim 2, wherein a thickness of the first light-shading layer is greater than a thickness of the bottom polarizer.

5. The display module of claim 2, wherein a thickness of the first light-shading layer is less than a thickness of the bottom polarizer, and the sum of thicknesses of the first light-shading layer and the adhesive layer is greater than the thickness of the bottom polarizer.

6. The display module of claim 2, wherein an area surrounded by the first light-shading layer is greater than the blind hole area, and the blind hole area is located in the area surrounded by the first light-shading layer.

7. The display module of claim 2, wherein an area surrounded by the first light-shading layer overlaps with the blind hole area.

8. The display module of claim 2, wherein an area surrounded by the first light-shading layer is less than the blind hole area, and the area surrounded by the first light-shading layer is in the blind hole area.

9. The display module of claim 6, wherein the second light-shading layer is formed on the LCD panel.

10. The display module of claim 9, wherein the area surrounded by the second light-shading layer overlaps with the blind hole area.

11. The display module of claim 9, wherein the area surrounded by the second light-shading layer is less than the blind hole area, and the blind hole area is located in the area surrounded by the second light-shading layer.

12. The display module of claim 9, wherein the area surrounded by the second light-shading layer is greater than the blind hole area, and the area surrounded by the second light-shading layer is in the blind hole area.

13. The display module of claim 7 or claim 8, wherein the second light-shading layer is formed on the first light-shading layer.

14. The display module of claim 13, wherein the area surrounded by the second light-shading layer overlaps with the area surrounded by the first light-shading layer.

15. A method for assembling a display module, comprising the following steps:
providing a liquid crystal display (LCD) panel, wherein a blind hole is defined in a position of the LCD panel corresponding to a camera lens;
attaching a polarizer and a blind hole protective film to the LCD panel, wherein a bottom polarizer and the blind hole protective film are attached to a light entrance side of the LCD panel, a first through hole is defined in a position of the bottom polarizer corresponding to the blind hole, a size of the first through hole is greater a size of a blind hole area, and the blind hole protective film is attached to the blind hole area;
forming a first light-shading layer by a first adhesive coating process, wherein the first light-shading layer is formed in the first through hole and is in contact with a periphery of the first through hole of the bottom polarizer;
attaching the LCD panel to a backlight module by an adhesive layer, wherein a second through hole is defined in a position of the backlight module corresponding to the blind hole;
forming a second light-shading layer by a second adhesive coating process, wherein the second light-shading layer is formed in the second through hole and is in contact with the adhesive layer and a periphery of the second through hole of the backlight module; and
peeling off the blind hole protective film.

16. The method of claim 15, wherein the step of attaching the LCD panel to the polarizer comprises:
attaching a top polarizer to a light exit side of the LCD panel, and attaching the bottom polarizer to the light entrance side of the LCD panel.

17. The method of claim 16, wherein the polarizer is attached to the LCD panel before the blind hole protective film is attached to the LCD panel.

18. The method of claim 16, wherein the polarizer is attached to the LCD panel after the blind hole protective film is attached to the LCD panel.

19. The method of claim 16, wherein the method comprises:
encapsulating the LCD panel after the polarizer is attached to the LCD panel.

20. The method of claim 15, wherein the first adhesive coating process comprises:
coating a light-shading adhesive on a recess surrounded by the bottom polarizer and the blind hole protective film by an inject printing process to form the first light-shading layer.
